(19) United States
(12) Patent Application Publication
(10) Pub. No.: US 2015/0305495 A1
(43) Pub. Date: Oct. 29, 2015

(54) SHEATHING DEVICE

(71) Applicant: DONGGUAN MASTER UNITED PLASTIC & HARDWARE PRODUCTS CO., LTD., Dongguan City (CN)

(72) Inventor: Tsung-Yu TSAI, Changhua City (TW)

(73) Assignee: DONGGUAN MASTER UNITED PLASTIC & HARDWARE PRODUCTS CO., LTD., Dongguan City (CN)

(21) Appl. No.: 14/259,649

(22) Filed: Apr. 23, 2014

(51) Int. Cl. A47B 63/00; F16B 7/04; A47B 47/00

(52) U.S. Cl. CPC A47B 63/00; A47B 47/0091; F16B 7/0486

(57) ABSTRACT

A sheathing device is formed of an L-shaped hollow tubular member, a longitudinal gap, an opening, a transversal gap, and a curved gap. The hollow tubular member includes a first tube wall, a second tube wall, and a curved tube wall. The curved tube wall extends to the second tube wall from the first tube wall and includes an internal wall surface and an external wall surface. The longitudinal gap longitudinally runs through the first tube wall and defines two longitudinal wall surfaces facing each other. The opening partially runs through the first tube wall and one of the two longitudinal wall surfaces. The transversal gap transversally runs through the second tube wall. The curved gap runs through the curved tube wall and communicates with the longitudinal and transversal gaps.

### BACKGROUND OF THE INVENTION

1. Field of the Invention

The present invention relates generally to a sheath and more particularly, to a sheathing device applied to a combination document rack.

2. Description of the Related Art

As the petroleum price rises, the freight cost becomes higher, so a variety of products, e.g. a combination document rack for office, for decreasing the freight cost and increasing the single loading capacity have been gradually developed.

Referring to FIG. 8, in a common combination document rack 50, after a connection bar 51 and a main body 52 are completely combined together, the joints between the connection bars 51 and the main body 52 are usually not structurally secure. The joints are indicated within imaginary circular broken lines, respectively. The main body 52 can be structurally knockdown. However, the combination document rack 50 is not structurally fixed, so the connection bars 51 can be easily detached to make the combination document rack 50 unfirm. Thus, it is necessary to additionally install a fastener to the combination document rack 50.

### SUMMARY OF THE INVENTION

The primary objective of the present invention is to provide a sheathing device which can firm up a combination document rack for preventing the combination document rack from easy disassembly.

The foregoing objective of the present invention is attained by the sheathing device formed of a hollow tubular member, a longitudinal gap, an opening, a transversal gap, and a curved gap. The hollow tubular member includes a first tube wall, a second tube wall, and a curved tube wall. The first tube wall includes a first end, a second end, a first internal wall surface, and a first external wall surface. The second tube wall includes a third end, a fourth end, a second internal wall surface, and a second external wall surface. The curved tube wall extends to the third end from the second end and includes an internal wall surface and an external wall surface. The longitudinal gap extends to the second end from the first end and runs through the first internal and external wall surfaces and defines two longitudinal wall surfaces facing each other. The opening partially runs through the first internal and external wall surfaces and one of the two longitudinal wall surfaces. The transversal gap extends to the fourth end from the third end and runs through the second internal and external wall surfaces. The curved gap runs through the internal and external wall surfaces of the curved tube wall and communicates with the longitudinal and transversal gaps.

In light of the structure mentioned above, when the sheathing device of the present invention is applied to the combination document rack, the sheathing device can firm up the structure of the combination document rack to prevent it from easy disassembly.

### BRIEF DESCRIPTION OF THE DRAWINGS

FIG. 1 is a perspective view of a preferred embodiment of the present invention.

FIG. 2 is a sectional view taken along a line 2-2 indicated in FIG. 1.

FIG. 3 is a sectional view taken along a line 3-3 indicated in FIG. 1.

FIG. 4 is a sectional view taken along a line 4-4 indicated in FIG. 1.

FIG. 5 is a sectional view taken along a line 5-5 indicated in FIG. 1.

FIG. 6 is a front view of the present invention.

FIG. 7 is a perspective view of the present invention applied to a combination document rack.

FIG. 8 is a schematic view of prior art, illustrating a common combination document track.

### DETAILED DESCRIPTION OF PREFERRED EMBODIMENTS

Structural features and desired effects of the present invention will become more fully understood by reference to a preferred embodiment given hereunder. However, it is to be understood that the embodiment is given by way of illustration only, thus is not limitative of the claim scope of the present invention.

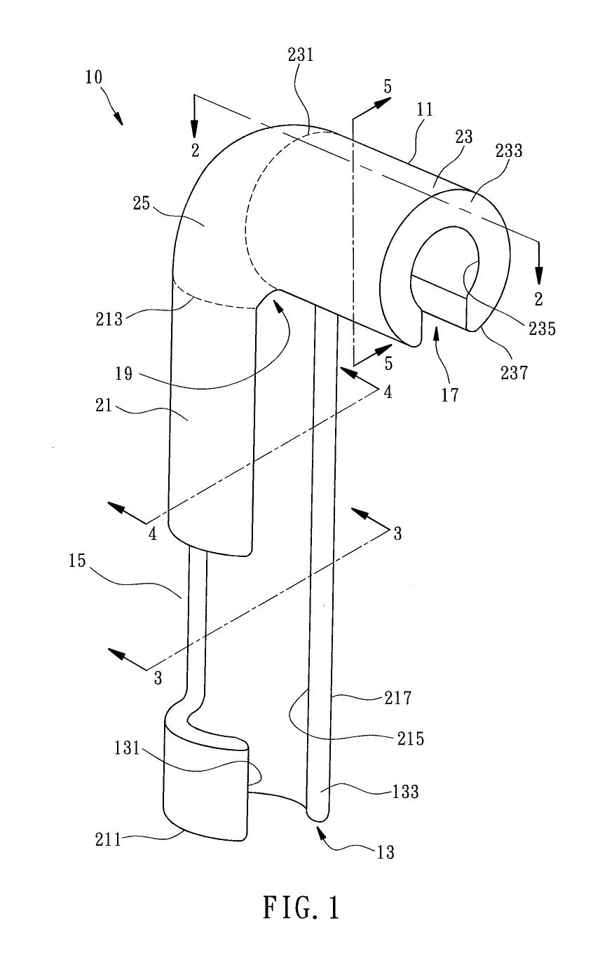

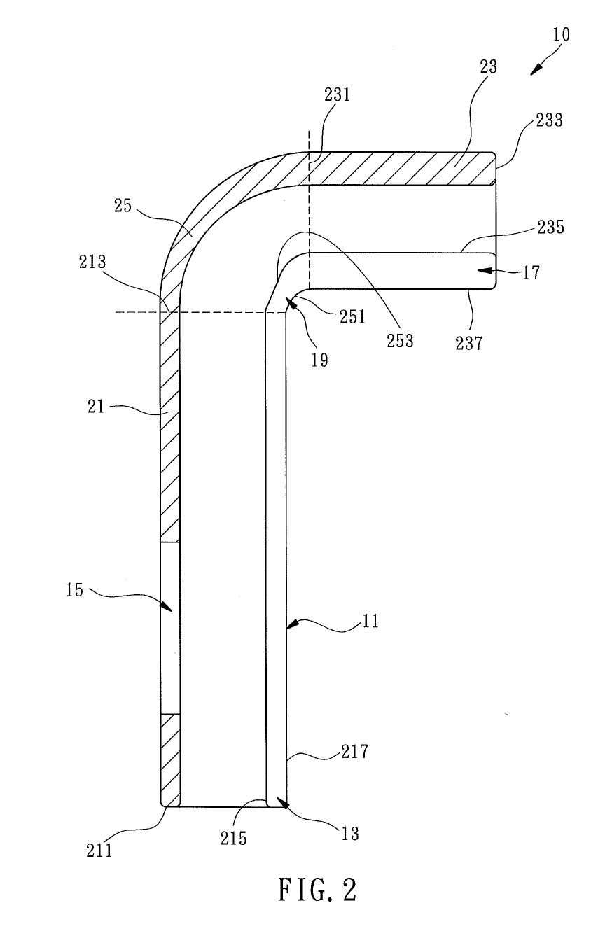

Referring to FIGS. 1 and 2, a sheathing device 10 constructed according to a preferred embodiment of the present invention is formed of a hollow tubular member 11, a longitudinal gap 13, an opening 15, a transversal gap 17, and a curved gap 19. The detailed descriptions and operations of these elements as well as their interrelations are recited in the respective paragraphs as follows.

The hollow tubular member 11 is L-shaped and includes a first tube wall 21, a second tube wall 23, and a curved tube wall 25. In fact, the hollow tubular member 11 is structurally one-piece. For clear illustration, circular broken lines are drawn for defining the ranges of the first tube wall 21, the second tube wall 23, and the curved tube wall 25, respectively, so the broken lines are imaginary and not provided on the hollow tubular member 11 actually. In practice, the hollow tubular member 11 is not limited to the character “L” in shape and can be of either of other sizes and geometric figures.

The first tube wall 21 includes a first end 211, a second end 213, a first internal wall surface 215, and a first external wall surface 217. The second tube wall 23 includes a third end 231, a fourth end 233, a second internal wall surface 235, and a second external wall surface 237. The curved tube wall 25 extends to the third end 231 from the second end 213 and includes an internal wall surface 251 and an external wall surface 253.

The longitudinal gap 13 extends to the second end 213 from the first end 211 and runs through the first internal and external wall surfaces 215 and 217. The longitudinal gap 13 defines two longitudinal wall surfaces 131 and 133 facing each other.

The opening 15 partially runs through the first internal wall surface 215, the first external wall surface 217, and one of the longitudinal wall surfaces 131 and 133. In other words, the opening 15 can be located at the left or right side of the first tube wall 21.

The longitudinal gap 17 extends to the fourth end 233 from the third end 231 and runs through the second internal and external wall surfaces 235 and 237.

The curved gap 19 runs through the internal and external wall surfaces 251 and 253 and communicates with the longitudinal and transversal gaps 13 and 17.

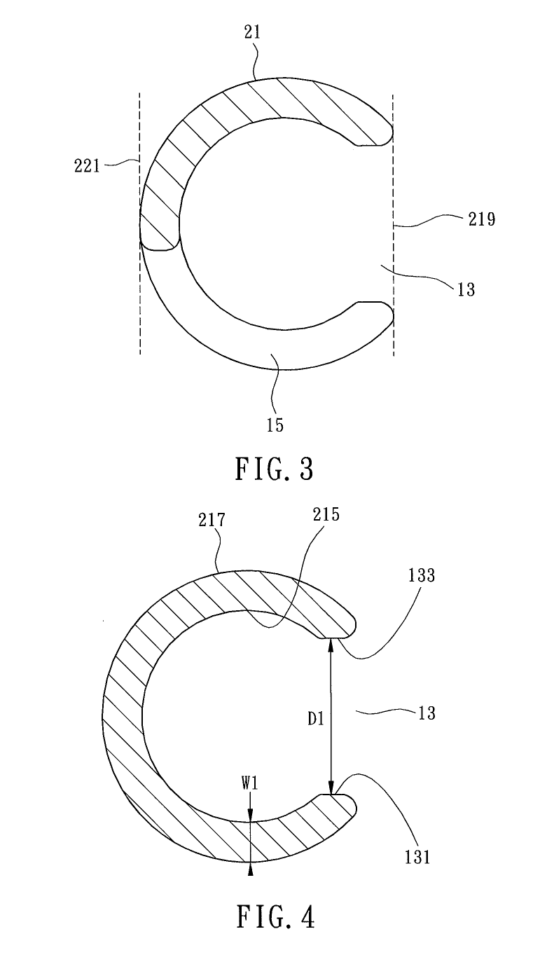

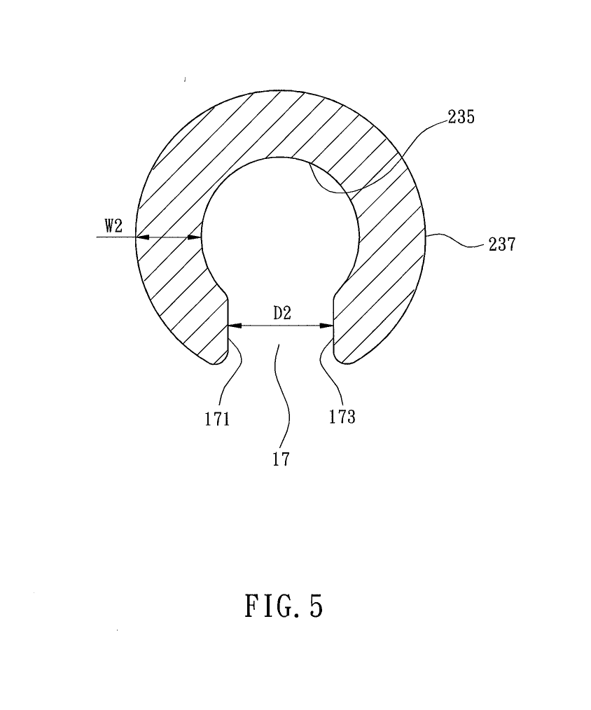

Referring to FIGS. 3 and 4, the first tube wall 21 includes a front side 219 and a rear side 221. The longitudinal gap 13 is located at the front side 219. The opening 15 extends to the rear side 221 from the front side 219. The two longitudinal wall surfaces 131 and 133 keep no contact with each other.

Referring to FIGS. 4 and 5, the transversal gap 17 defines two transversal wall surfaces 171 and 173 facing each other. The two transversal wall surfaces 171 and 173 keep no contact with each other. A distance D1 between the two longitudinal wall surfaces 131 and 133 is larger than a distance D2 between the two transversal wall surfaces 171 and 173. The thickness W1 of the first tube wall 21, between the first internal wall surface 215 and the first external wall surface 217, is smaller than the thickness W2 of the second tube wall 23 between the second internal wall surface 235 and the second external wall surface 237.

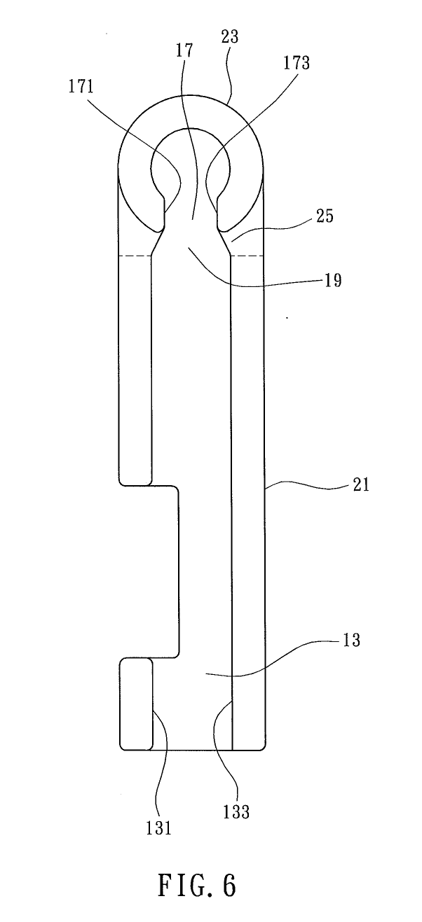

Referring to FIG. 6, each of the first tube wall 21, the second tube wall 23, and the curved tube wall 25 has the same external diameter.

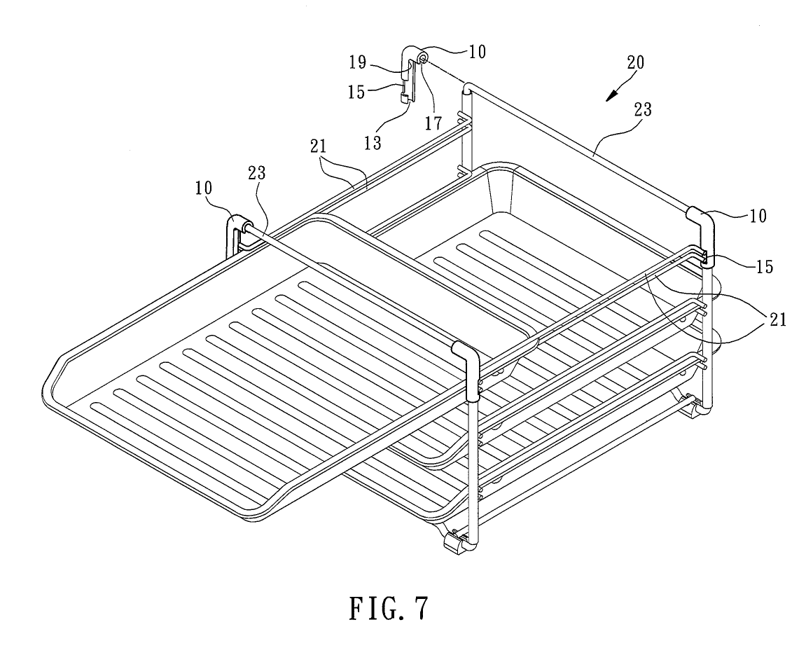

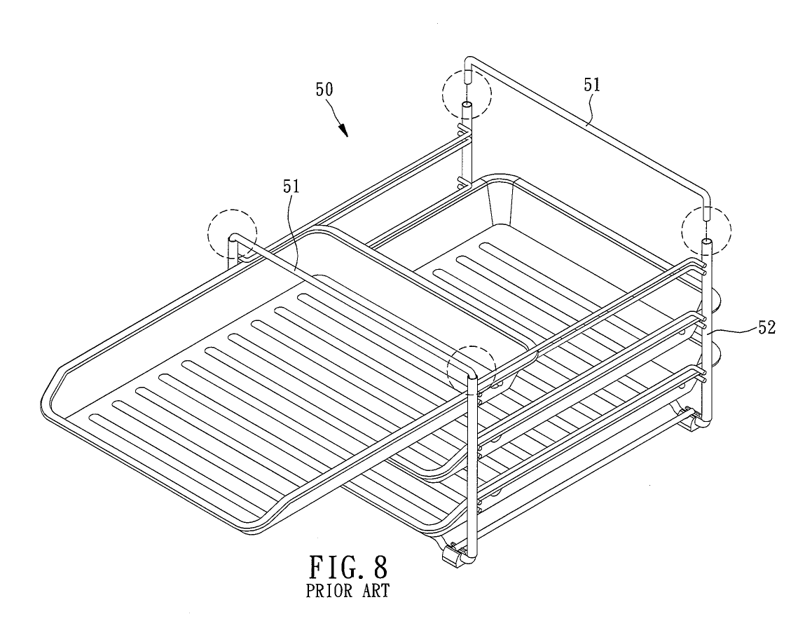

The sheathing device 10 of the present invention is to firm up connections between components of either of a variety of combination document racks. Referring to FIG. 7, after the longitudinal gap 13, the transversal gap 17, and the curved gap 19 are aligned with the combination document rack 20, the sheathing device 10 can be sleeved onto either of L-shaped parts of the combination document rack 20.

Specifically, the opening 15 is to receive a trackway 21 of the combination document rack 20, so a connection bar 23 located on a top side of the combination document rack 20 cannot be easily detached. In this way, the sheathing device 10 can firm up the structure of the combination document rack 20.

What is claimed is:

1. A sheathing device comprising:
a hollow tubular member having a first tube wall, a second tube wall, and a curved tube wall, the first tube wall having a first end, a second end, a first internal wall surface, and a first external wall surface, the second tube wall having a third end, a fourth end, a second internal wall surface, and a second external wall surface, the curbed tube wall extending to the third end of the second tube wall from the second end of the first tube wall and having an internal wall surface and an external wall surface;
a longitudinal gap extending to the second end of the first tube wall from the first end of the first tube wall and running through the first internal and external wall surfaces, the longitudinal gap defining two longitudinal wall surfaces facing each other;
an opening partially running through the first internal and external wall surfaces and one of the two longitudinal wall surfaces;
a transversal gap extending to the fourth end of the second tube wall from the third end of the second tube wall and running through the second internal and external wall surfaces; and
a curved gap running through the internal and external wall surfaces of the curbed tube wall and communicating with the longitudinal and transversal gaps.

2. The sheathing device as defined in claim 1, wherein the first tube wall comprises a front side and a rear side; the longitudinal gap is located at the front side of the first tube wall; the opening extends to the rear side of the first tube wall from the front side of the first tube wall.

3. The sheathing device as defined in claim 1, wherein the transversal gap defines two transversal wall surfaces facing each other, the two transversal wall surfaces keeping no contact with each other; the two longitudinal wall surfaces of the longitudinal gap keeps no contact with each other.

4. The sheathing device as defined in claim 3, wherein the two longitudinal wall surfaces of the longitudinal gap comprise a distance therebetween that is larger than a distance between the two transversal wall surfaces of the transversal gap.

5. The sheathing device as defined in claim 1, wherein each of the first tube wall, the second tube wall, and the curved tube wall comprises the same external diameter.

6. The sheathing device as defined in claim 5, wherein the first tube wall comprises a thickness between the first internal and external wall surfaces, said thickness being smaller than that of the second tube wall between the second internal and external wall surfaces.

7. The sheathing device as defined in claim 1, wherein the hollow tubular member is L-shaped.
